(19) United States
(12) Patent Application Publication
(10) Pub. No.: US 2007/0181170 A1
(43) Pub. Date: Aug. 9, 2007

(54) Apparatus including an improved nozzle unit

(76) Inventors: Kyoung-Ho Kim, Suwon-si (KR); Young-Chul Jang, Hwaseong-si (KR)

Correspondence Address: LEE & MORSE, P.C., 3141 FAIRVIEW PARK DRIVE, SUITE 500, FALLS CHURCH, VA, 22042, US

(21) Appl. No.: 11/702,612

(22) Filed: Feb. 6, 2007

(30) Foreign Application Priority Data
Feb. 8, 2006 (KR) 2006-11942

(51) Int. Cl. B08B 3/00; B08B 3/12; B08B 6/00

(52) U.S. Cl. 134/103.2; 134/198; 134/103.3; 134/172

(57) ABSTRACT

An apparatus for supplying a solution to a substrate includes a nozzle unit. The nozzle unit may include at least one nozzle having a variable structure in which lateral portions of the at least one nozzle are bent toward a central portion of the at least one nozzle. Each nozzle of the nozzle unit may include a hinged connecting member disposed at the central portion of each of the nozzles. The hinge angles between lateral portions of each of the nozzles may vary during operation. Each of the nozzles may include a plurality of spray holes for uniformly providing a developing solution onto the photoresist film. Some of the plurality of holes positioned near the central portion of the nozzles may be substantially wider than some of the plurality of holes positioned near lateral portions of the nozzles.

### BACKGROUND OF THE INVENTION

1. Field of the Invention

The present invention relates to an apparatus employed in semiconductor manufacturing processes. More particularly, the present invention relates to an apparatus that includes an improved nozzle unit for uniformly providing a solution to a substrate.

2. Description of the Related Art

Semiconductor manufacturing processes generally include one or more photo processes, an etching process and a cleaning process in order to form a desired pattern on a semiconductor substrate. The series of photo processes typically includes coating a photoresist film on the semiconductor substrate, exposing the coated photoresist film, and developing the exposed photoresist film. The photoresist film that is coated on the semiconductor substrate may be exposed using a predetermined photo mask, and then the exposed photoresist film may be developed using a developing apparatus.

FIG. 1 illustrates a perspective view of a developing apparatus according to a related art.

Referring to FIG. 1, a related art developing apparatus may include a spin chuck 10, a knife ring 15 and a nozzle 5. A photoresist film may be coated on a semiconductor substrate W, and the coated photoresist film may be exposed using a predetermined photo mask. The semiconductor substrate W may then be loaded onto the spin chuck 10. A developing solution 20 may be sprayed onto the photoresist film from the nozzle 5 while moving the nozzle 5 across the wafer W as indicated by an arrow in FIG. 1. The knife ring 15 may be disposed around the semiconductor substrate W. As the developing solution 20 is provided onto the exposed photoresist film, the predetermined photoresist pattern may be developed. That is, an exposed portion of the photoresist film may be removed by the developing solution so that the predetermined photoresist pattern may be formed on the semiconductor substrate W.

In the typical developing process, the desired photoresist pattern may be developed properly when the semiconductor substrate is relatively small, e.g., about 12 inches wide. However, when the semiconductor substrate is about 18 inches wide, the photoresist film may not be uniformly developed using the typical developing apparatus. In addition, the processing time for the developing process may be considerably increased with the typical developing apparatus. This is because the nozzle that sprays the developing solution onto the photoresist film is capable of only linear motion. Thus, the time differential between starting the spray at one end of the semiconductor substrate and finishing the spray at the other end of the semiconductor substrate may be significant for large substrates. For example, when the semiconductor substrate is about 12 inches wide, the time differential may be about 5.5 seconds. However, the differential increases to about 8.3 seconds when the semiconductor substrate is about 18 inches wide. The large time differential means that the photoresist film may not be developed uniformly across the entire substrate. The result is that the predetermined photoresist pattern may not have desired dimensions or details. As the level of precision required of a semiconductor device has increased, the time differential has become a serious problem.

### SUMMARY OF THE INVENTION

The present invention is therefore directed to an apparatus for providing a solution to a substrate, including a nozzle unit having an improved structure to provide the solution onto the substrate evenly, which overcomes one or more of the problems due to the limitations and disadvantages of the related art.

Therefore, an example embodiment of the present invention provides an apparatus having a nozzle unit that may include at least one nozzle having a variable geometry for providing a solution to a substrate.

Another example embodiment of the present invention provides an apparatus having a nozzle unit that rapidly and uniformly provides the solution.

Still another example embodiment of the present invention provides an apparatus having a nozzle unit that decreases time needed to apply the solution.

At least one of the above and other features and advantages may be realized as providing an apparatus for providing a solution to a substrate including a support for the substrate, and a nozzle unit adjacent the support, the nozzle unit including at least a first nozzle having a variable geometry in which lateral portions of the first nozzle are adapted to be adjustable about at a central portion of the first nozzle as the nozzle unit traverses over the substrate.

The first nozzle may be disposed adjacent to a first end portion of the substrate. The nozzle unit may further include a second nozzle disposed adjacent to a second end portion of the substrate, the second nozzle being substantially opposed to the first nozzle. The first nozzle and the second nozzle may be at least as long as a width of the substrate.

The nozzle unit may include a third nozzle and a fourth nozzle. The first through the fourth nozzles may be disposed at predetermined intervals around a circumference of the substrate. The first and the second nozzles may be substantially opposed to the third and the fourth nozzles, respectively. Each of the first through the fourth nozzles may be at least as long as a half of a width of the substrate.

Each of the nozzles may include a plurality of spray holes. Some of the plurality of spray holes disposed near a central portion of each of the nozzles may be substantially wider than some of the plurality of holes formed at lateral portions of the nozzles. A speed of the central portion may be different from the speed of the lateral portions as the nozzles traverse the substrate.

Each nozzle of the nozzle unit may include a hinged member disposed at the central portion of each of the nozzles. Hinge angles between lateral portions of each of the nozzles may vary, e.g., may increase or decrease, as the nozzles move towards a center of the substrate.

When the first and the second nozzles are adjacent a periphery of the substrate, the hinge angle of each of the first and the second nozzles may be about 45 degrees. When the first and the second nozzles are adjacent the center of the substrate, the hinge angle of each of the first and the second nozzles may be about 180 degrees.

When more than two nozzles are adjacent a periphery of the substrate, the hinge angles may be obtuse. When more than two nozzles are adjacent the center of the substrate, the hinge angle of each of the nozzles may be about 90 degrees.

### BRIEF DESCRIPTION OF THE DRAWINGS

The above and other features and advantages of the present invention will become more apparent to those of ordinary skill in the art by describing in detail example embodiments thereof with reference to the attached drawings, in which:

FIG. 1 illustrates a perspective view of a related developing apparatus;

FIG. 2 illustrates a plan view of a nozzle unit of a developing apparatus in accordance with a first embodiment of the present invention;

FIGS. 3 and 4 illustrate plan views of a variable-angle nozzle unit of FIG. 2 during a developing process according to exemplary embodiments of the present invention;

FIGS. 5 to 7 illustrate plan views of a variable-angle nozzle unit in a developing process according to exemplary embodiments of the present invention; and

FIG. 8 illustrates a bottom plan view of a nozzle for a variable-angle nozzle unit according to exemplary embodiments of the present invention.

### DETAILED DESCRIPTION OF THE INVENTION

The present invention is described more fully hereinafter with reference to the accompanying figures, in which example embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the present invention to those skilled in the art. In the figures, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another elements or features as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented rotated 90 degrees or at other orientations and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

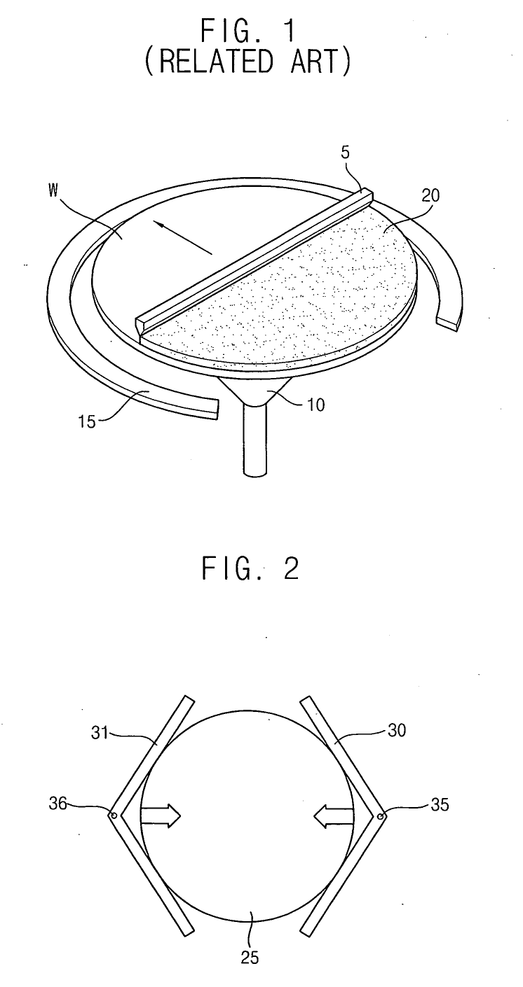

As described with respect to the following example embodiments as discussed herein, the developing apparatus in accordance with embodiments of the present invention may include the spin chuck 10 and the knife ring 15 of FIG. 1. For ease of understanding, these elements are not apparent in the plan views of FIGS. 2 to 7.

FIG. 2 illustrates a plan view of a nozzle unit of a developing apparatus in accordance with an example embodiment of the present invention.

Referring to FIG. 2, a first and a second nozzles 30 and 31 may be disposed over a substrate 25 that has been loaded on the spin chuck 10.

The substrate 25 may include a semiconductor substrate or a metal oxide substrate, e.g., silicon, germanium, silicon germanium, silicon-on-insulator (SOI), aluminum oxide, etc. The substrate 25 may be coated with a photoresist film before being loaded onto the spin chuck 10. The spin chuck 10 may rotate the substrate 25 at a predetermined rotation speed. The photoresist film coated on the substrate 25 may be exposed using a photo mask having a predetermined pattern. That is, the predetermined pattern may be transcribed to the photoresist film in an exposure process. In some example embodiments of the present invention, the substrate 25 may include an additional structure, e.g., a conductive layer pattern, an insulation layer, a pad, an electrode, a contact region, a gate structure and/or a transistor.

The first and the second nozzles 30 and 31 of the nozzle unit may apply a developing solution onto the photoresist film on the substrate 25. The first nozzle 30 may be disposed adjacent to a first end portion of the substrate 25, and the second nozzle 31 may be positioned adjacent to a second end portion of the substrate 25. The first nozzle 30 may be substantially opposed to the second nozzle 31, as illustrated in FIG. 2.

The first nozzle 30 and the second nozzle 31 may include a first hinged connecting member 35 and a second hinged connecting member 36, respectively. Both lateral portions of the first nozzle 30 and the second nozzle 31 may pivot about its respective hinge. The lateral portions of the first nozzle 30 and the second nozzle 31 may rotate around the hinge connecting members 35 and 36 up to about 360°. The hinge connecting member 35 may include a conduit to provide the developing solution to the lateral portions of the first nozzle 30. The hinge connecting member 36 may include a conduit to provide the developing solution to the lateral portions of the second nozzle 31.

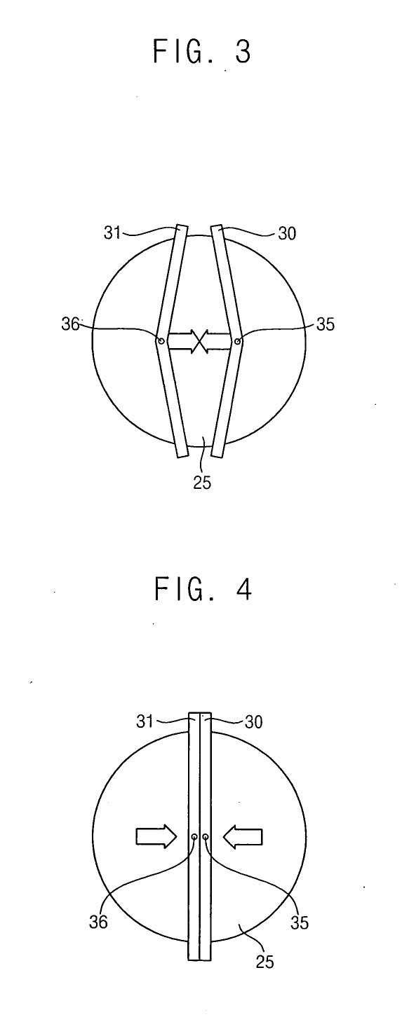

FIGS. 3 and 4 illustrate how the first nozzle 30 may move over the substrate 25 from the first end portion of the substrate 25 to a central portion of the substrate 25 in the developing process. The first hinge 35 may be positioned at a central portion of the first nozzle 30. The lateral portions of the first nozzle 30 may be pivoted about the first hinge 35 at various angles. Thus, the first nozzle 30 may embody various arrangements in accordance with the hinge angles between the lateral portions thereof. In an initial step of the developing process for the photoresist film, the first nozzle 30 may form a V-shape adjacent the first end portion of the substrate 25. As the developing process progresses, the bending angle between the lateral portions of the first nozzle 30 may be gradually increased.

As illustrated in FIG. 4, in a final step of the developing process, the first nozzle 30 may have a linear structure, e.g., a hinge angle of 180 degrees, as it arrives at the central portion of the substrate 25. Each of the first and the second nozzles 30 and 31 may have a variable structure throughout the predetermined developing process. As a result, the velocity and direction of the lateral portions of the first and the second nozzles 30 and 31 over the substrate 25 may be substantially different from the velocity and direction of the central portions of the first and the second nozzles 30 and 31 during the predetermined developing process. The hinge angle between the lateral portions of the first and the second nozzles 30 and 31 may be gradually increased as the first and the second nozzles 30 and 31 move from the end portions of the rotating substrate 25 toward the central portion of the rotating substrate 25.

The first and the second nozzles 30 and 31 may be at least as long as a width of the substrate 25 so that the first and the second nozzles 30 and 31 may apply a sufficient amount of developing solution onto the photoresist film formed on the substrate 25 in a timely manner. In an example embodiment, the first and the second nozzles 30 and 31 may have a plurality of spray holes for uniformly applying the developing solution onto the photoresist film on the substrate 25.

The initial hinge angles for the first and the second nozzles 30 and 31 and/or the final hinge angles of the first and the second nozzles 30 and 31 may be varied in accordance with various conditions, e.g., the flow rate of the developing solution, the rotation speed of the substrate 25, and the velocity and direction of the first and the second nozzles 30 and 31 over the substrate 25. The flow rate for delivery of the developing solution onto the photoresist film may be adjusted to account for variations in the hinge angles of the first and the second nozzles 30 and 31 and the size of the substrate 25.

Hereinafter, variations in the configuration of the first and the second nozzles 30 and 31 relative to the progression of the developing process will be described in detail.

FIGS. 2 to 4 illustrate plan views of configuration variations of a nozzle unit in accordance with example embodiments of the present invention. As shown in FIG. 2, the first and the second nozzles 30 and 31 may be disposed adjacent to the first and the second end portions of the substrate 25 in the initial step of the developing process. The first and the second nozzles 30 and 31 may be substantially opposed to each other. The first and the second nozzles 30 and 31 may have predetermined hinge angles which may be adjusted for a variety of conditions, e.g., the flow rate of the developing solution, the rotation speed of the substrate 25, the velocities and directions of the first and the second nozzles 30 and 31 over the substrate 25, etc. FIG. 2 illustrates that the first and the second nozzles 30 and 31 may each have a V-shape in the initial step of the developing process. The first and the second nozzles 30 and 31 may move toward the central portion of the substrate 25 as the developing process proceeds.

Referring to FIG. 3, the first and the second nozzles 30 and 31 may move from the first and the second end portions of the substrate 25 toward the central portion of the substrate 25, as indicated by arrows. The developing solution may be sprayed from the first and the second nozzles 30 and 31 onto the photoresist film coated on the substrate 25, while the first and the second nozzles 30 and 31 move over the substrate 25.

Referring to FIG. 4, the first nozzle 30 may make contact with the second nozzle 31 over the central portion of the substrate 25 in the final step of the developing process. Thus, the hinge bending angles of the first and the second nozzles 30 and 31 may be increased beyond the angles illustrated in FIGS. 2 and 3.

Notice that the hinge angles are different between FIGS. 2 to 4. The change in the hinge angle means that, as the first and the second nozzles 30 and 31 move across the substrate 25, the velocities of the lateral portions of the first and the second nozzles 30 and 31 may be substantially different from the velocities of the central portions of the first and the second nozzles 30 and 31. The hinge bending angles of the first and the second nozzles 30 and 31 may vary in accordance with the predetermined developing process, and the flow rate for the developing solution provided through the first and the second nozzles 30 and 31 onto the photoresist film may also be varied. The result of the hinge angle and flow rate adjustments is that the application rate of the developing solution onto the central portion of the photoresist film on the substrate 25 may be substantially the same as that the application rate of the developing solution at a peripheral portion of the photoresist film. Thus, the developing solution may be uniformly applied onto the entire photoresist film-coated substrate 25.

Upon completion of the photoresist film developing process, the first and the second nozzles 30 and 31 may return to the initial positions adjacent to the first and the second end portions of the substrate 25.

When a photoresist film is developed using the nozzle unit described above, the developing solution may be uniformly and rapidly applied onto the photoresist film. Thus, the time required for the developing process may be considerably reduced. In addition, minute patterns having uniform critical dimensions (CD) may be formed on the substrate 25 because the photoresist film may be uniformly developed to form the intricate photoresist pattern. As a result, a semiconductor device which includes components manufactured via this apparatus may have improved reliability and enhanced electrical characteristics.

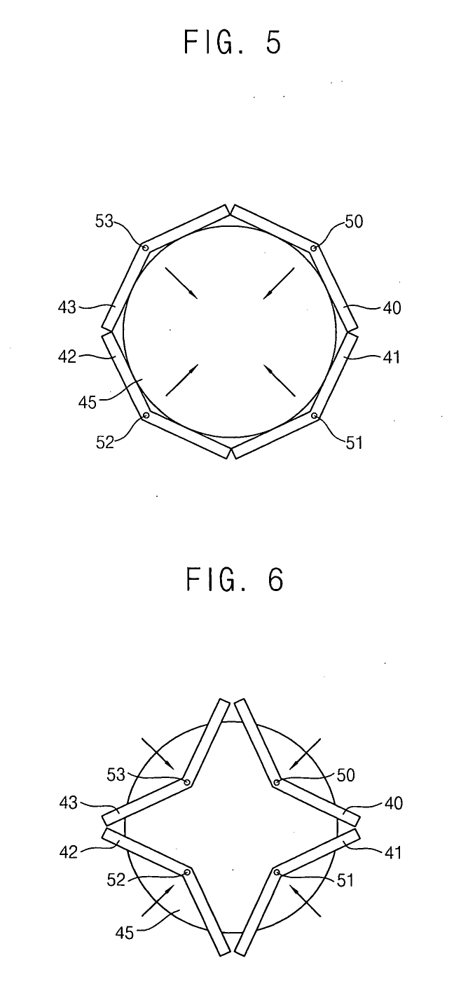

FIG. 5 illustrates a plan view of a nozzle unit of a developing apparatus in accordance with an example embodiment of the present invention.

Referring to FIG. 5, the developing apparatus may include a nozzle unit which may include a first nozzle 40, a second nozzle 41, a third nozzle 42 and a fourth nozzle 43. The first through the fourth nozzles 40, 41, 42 and 43 may be disposed on a substrate 45 that has been loaded onto the spin chuck 10.

The substrate 45 may include a semiconductor substrate or a metal oxide substrate, e.g., silicon, germanium, silicon germanium, SOI, aluminum oxide, etc. The substrate 45 may include an additional structure, e.g., a conductive layer pattern, an insulation layer, a pad, an electrode, a contact region, a gate structure and/or a transistor.

The substrate 45 may be coated with a photoresist film to cover the additional structure before being loaded onto the spin chuck 10. The spin chuck 10 may rotate the substrate 45 at a predetermined rotation speed. The photoresist film may be exposed using a photo mask having a predetermined pattern. Thus, the predetermined pattern may be transcribed to the photoresist film coating.

In an example embodiment of the present invention, the nozzle unit may include the first to the fourth nozzles 40, 41, 42 and 43 to apply a developing solution onto the photoresist film uniformly and rapidly. The first to the fourth nozzles 40, 41, 42 and 43 may have structures substantially the same as the first and the second nozzles 30 and 31 in FIG. 2, except for their relative dimensions.

The nozzle unit may include a first hinged connecting member 50, a second hinged connecting member 51, a third hinged connecting member 52 and a fourth hinged connecting member 53, which may be disposed at a central portion of the first to the fourth nozzles 40, 41, 42 and 43, respectively. Each hinged connecting member 50, 51, 53 and 53 may include a conduit to provide developing solution to the lateral portions of the respective first to the fourth nozzles 40, 41, 42 and 43. The hinge angles of the first to the fourth nozzles 40, 41, 42 and 43 may be varied in operation according to the first to the fourth hinged connecting members 50, 51, 52 and 53. That is, each of the first to the fourth nozzles 40, 41, 42 and 43 may have a symmetrically variable structure centered on the first to the fourth hinged connecting members 50, 51, 52 and 53. For example, each of the first to the fourth nozzles 40, 41, 42 and 43 may be bent at their hinged member 50, 51, 52 and 53, up to about 360°.

Each of the first to the fourth nozzles 40, 41, 42 and 43, may include a plurality of spray holes to apply a developing solution uniformly onto the photoresist film. The sizes of the spray holes may be varied to provide a range of application rates for the developing solution. The larger spray holes, which may be at the central portions of the first to the fourth nozzles 40, 41, 42 and 43, may be gradually reduced toward the lateral portions of the first to the fourth nozzles 40, 41, 42 and 43. For example, some of the spray holes at the central portions of the first to the fourth nozzles 40, 41, 42 and 43, may be the largest spray holes on the first to the fourth nozzles 40, 41, 42 and 43, while other spray holes at the lateral portions of the first to the fourth nozzles 40, 41, 42 and 43, may be the smallest. Thus, the application rate of the developing solution onto the photoresist film at the central portion of the substrate 45 may be substantially identical to the application rate of the developing solution at the periphery of the substrate 45.

When the substrate 45 is divided into four regions having substantially identical areas, each of the first to the fourth nozzles 40, 41, 42 and 43 may be disposed adjacent to one of the four regions whereby the first to the fourth nozzles 40, 41, 42 and 43 effectively surround the substrate 45. The first and the second nozzles 40 and 41 may be substantially opposed to the third and the fourth nozzles 42 and 43, respectively. Each of the first to the fourth nozzles 40, 41, 42 and 43 may be at least as long as a half of a width of the substrate 45.

In an initial step of the developing process for the photoresist film, each of the first through the fourth nozzles 40, 41, 42 and 43 may include hinge angles above about 90°. However, in a final step of the developing process the first through the fourth nozzles 40, 41, 42 and 43 may include hinge angles of about 90°. Thus, the nozzle unit may form an X- or cross-shape in the final step of the developing process. As the developing process progresses, the hinge angles of the first through the fourth nozzles 40, 41, 42 and 43 may vary between the angle illustrated in the initial step and the final step. The velocity of the lateral portions of the first through the fourth nozzles 40, 41, 42 and 43 may be substantially different from the velocity of the central portions of the first through the fourth nozzles 40, 41, 42 and 43, as the hinge angles are gradually reduced.

In some exemplary embodiments of the present invention, the initial hinge angles through to the final hinge angles of the first through the fourth nozzles 40, 41, 42 and 43 may be varied in accordance with various conditions, e.g., flow rate of the developing solution, rotation speed of the substrate 45, velocities and directions of the first through the,fourth nozzles 40, 41, 42 and 43, etc. The application rate of the developing solution onto the photoresist film may be advantageously adjusted in accordance with variations of the hinge angles of the first through the fourth nozzles 40, 41, 42 and 43.

Hereinafter, structural variations of the first through the fourth nozzles 40, 41, 42 and 43 relative to a progression of the developing process will be described in detail.

FIGS. 5 to 7 illustrate plan views of the variable-angle nozzle unit in accordance with the second embodiment of the present invention.

Referring to FIG. 5, the first through the fourth nozzles 40, 41, 42 and 43 may be disposed adjacent to the periphery of the substrate 45 so as to substantially surround the substrate 45, in the initial step of the developing process. The hinge angles of the first through the fourth nozzles 40, 41, 42 and 43 may be adjusted to predetermined angles based upon a variety of conditions, e.g., the flow rate of the developing solution, the rotation speed of the substrate 45, the velocities and directions of the first through the fourth nozzles 40, 41, 42 and 43, etc. The arrangement of the first through the fourth nozzles 40, 41, 42 and 43 may progress across the substrate 45 and toward the central portion of the substrate 45 as indicated by the arrows in FIGS. 5-7.

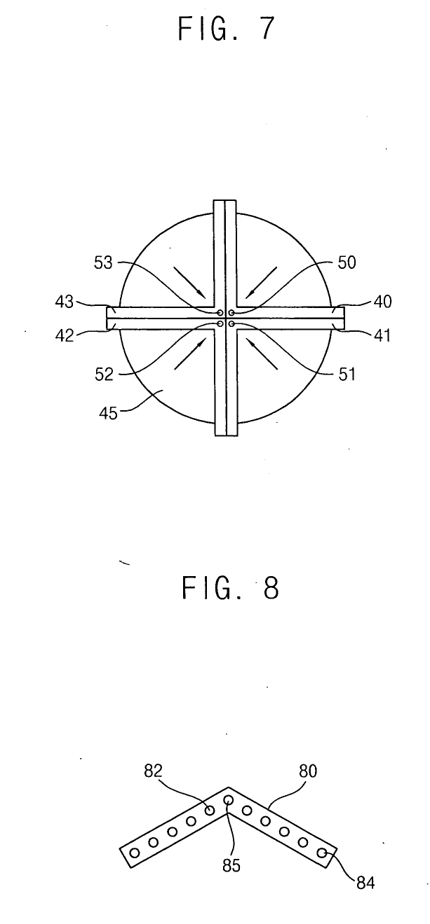

Referring to FIG. 6, the developing solution may be applied to the substrate 45 while moving the first through the fourth nozzles 40, 41, 42 and 43 from the peripheral portion of the substrate 45 toward the central portion of the substrate 45. Referring to FIG. 7, the first through the fourth nozzles 40, 41, 42 and 43 may make contact with one another over the central portion of the substrate 45 near the final step of the developing process. The hinge angles of the first through the fourth nozzles 40, 41, 42 and 43 illustrated in FIG. 6, are further reduced to about 90°. Hence, the first through the fourth nozzles 40, 41, 42 and 43 collectively form an X- or cross-shape in that step of, the developing process.

Throughout the process, the angles between the lateral portions of the first through the fourth nozzles 40, 41, 42 and 43 may be gradually decreased, resulting in a wide velocity variation between the lateral portions and the center portion of each of the first through the fourth nozzles 40, 41, 42 and 43. The velocities of the first through the fourth nozzles 40, 41, 42 and 43 may be controlled to deliver brief and uniform applications of the developing solution onto the photoresist film.

As the hinge angles of the first through the fourth nozzles 40, 41, 42 and 43 vary in accordance with the predetermined progression of the developing process, the flow rate of the developing solution may also be adjusted. Thus, the application rate of the developing solution at the central portion of the substrate 45 may be substantially the same as at the periphery of the substrate 45. A uniform application of developing solution means that the photoresist pattern formed on the substrate 45 may have the desired form and detail. After completing the developing process for forming the photoresist pattern, the first through the fourth nozzles 40, 41, 42 and 43 may return to an initial position adjacent to the periphery of the substrate 45.

As discussed above, in embodiments of the present invention, spray holes size in a nozzle may be varied to provide a range of application rates for the developing solution. FIG. 8 illustrates a plan view of a bottom of nozzle 80, i.e., a surface of the nozzle 80 facing a substrate, which may be employed in the embodiments of the present invention. The nozzle 80 may include a channel for the solution, the channel being in fluid communication with spray holes in this bottom surface. As can be seen therein, the nozzle 80 may include spray holes 82 at a central portion thereof that are larger than spray holes 84 away from a central portion where the hinge 85 is located. For example, some of the spray holes 82 at the central portions of the nozzle 80 may be the largest on the nozzle 80, while spray holes 84 at lateral portions of the nozzle 80 may be the smallest. For example, spray holes of the nozzle 80 may be gradually reduced in size from a central portion toward the lateral portions of the nozzle 80. Any or all of the above-described nozzles 30, 31, 40, 41, 42, 43 may have this structure. Thus, the application rate of the developing solution onto the photoresist film at the central portion of the substrate may be substantially identical to the application rate of the developing solution at the periphery of the substrate.

In some example embodiments of the present invention, the developing apparatus may include a nozzle unit having at least one ring-shaped nozzle disposed adjacent to a substrate. The ring-shaped nozzle may further reduce the time required for more evenly applying a developing solution onto a photoresist film coated on the substrate.

According to the present invention, a developing apparatus may include a nozzle unit that includes at least one nozzle having a variable structure in accordance with a developing process for a photoresist film formed on a substrate. The apparatus may enable a developing solution to be rapidly and uniformly applied onto the photoresist film so that a detailed photoresist pattern may be formed on the substrate. A semiconductor formed by such an apparatus may exhibit improved reliability and enhanced electrical characteristics. Additionally, the time required to manufacture the semiconductor device may be reduced due to the decreasing time required to apply the developing solution.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An apparatus for providing a solution on a substrate, comprising:
a support for the substrate; and
a nozzle unit adjacent the support, the nozzle unit including at least a first nozzle having a variable geometry in which lateral portions of the first nozzle are adapted to be adjustable about at a central portion of the first nozzle as the nozzle unit traverses over the substrate.

2. The apparatus as claimed in claim 1, wherein the first nozzle is disposed adjacent to a first end portion of the substrate, the nozzle unit further comprising:
a second nozzle disposed adjacent to a second end portion of the substrate, the second nozzle being substantially opposed to the first nozzle.

3. The apparatus as claimed in claim 2, wherein the first nozzle and the second nozzle are at least as long as a width of the substrate.

4. The apparatus as claimed in claim 2, wherein each of the first and the second nozzles includes a plurality of spray holes, some of the plurality of spray holes disposed near a central portion of each of the first and the second nozzles are substantially wider than some of the plurality of holes formed at lateral portions of the first and the second nozzles.

5. The apparatus as claimed in claim 4, wherein a speed of the central portion is substantially different from the speed of the lateral portions as the first and the second nozzles traverse over the substrate.

6. The apparatus as claimed in claim 2, wherein the nozzle unit further comprises:
a first hinged member at a central portion of the first nozzle; and
a second hinged member at a central portion of the second nozzle.

7. The apparatus as claimed in claim 6, wherein hinge angles between lateral portions of the first and the second nozzles vary as the first and the second nozzles move towards a center of the substrate.

8. The apparatus as claimed in claim 7, wherein hinge angles between lateral portions of the first and the second nozzles increase as the first and the second nozzles move towards a center of the substrate.

9. The apparatus as claimed in claim 8, wherein, when the first and the second nozzles are adjacent a periphery of the substrate, the hinge angle of each of the first and the second nozzles may be about 45 degrees.

10. The apparatus as claimed in claim 8, wherein, when the first and the second nozzles are adjacent the center of the substrate, the hinge angle of each of the first and the second nozzles is about 180 degrees.

11. The apparatus as claimed in claim 10, wherein the nozzle unit further comprises a third nozzle and a fourth nozzle, the first through the fourth nozzles being disposed at predetermined intervals around a circumference of the substrate.

12. The apparatus as claimed in claim 11, wherein the first and the second nozzles are substantially opposed to the third and the fourth nozzles, respectively.

13. The apparatus as claimed in claim 11, wherein each of the first through the fourth nozzles is at least as long as a half of a width of the substrate.

14. The apparatus as claimed in claim 11, wherein each of the first through the fourth nozzles includes a plurality of spray holes, some of the plurality of spray holes disposed near a central portion of each of the first through the fourth nozzles are substantially wider than some of the plurality of holes formed at lateral portions of the first through the fourth nozzles.

15. The apparatus as claimed in claim 14, wherein a speed of the central portion is substantially different from the speed of the lateral portions as the nozzles traverse the substrate.

16. The apparatus as claimed in claim 11, wherein each of the first through the fourth nozzles of the nozzle unit further comprises a hinged member disposed at the central portion of each of the nozzles.

17. The apparatus as claimed in claim 16, wherein hinge angles between lateral portions of each of the first through the fourth nozzles vary as the first through the fourth nozzles move towards a center of the substrate.

18. The apparatus as claimed in claim 17, wherein hinge angles between lateral portions of each of the first through the fourth nozzles decrease as each of the first through the fourth nozzles move towards the center of the substrate.

19. The apparatus as claimed in claim 18, wherein the hinge angle of each of the first through the fourth nozzles has an obtuse angle when each of the first through the fourth nozzles is adjacent a periphery of the substrate.

20. The apparatus as claimed in claim 18, wherein, when each of the first through the fourth nozzles is adjacent the center of the substrate, the hinge angle of each of the first through the fourth nozzles is about 90 degrees.
